(19) United States
(12) Patent Application Publication
(10) Pub. No.: US 2014/0262699 A1
(43) Pub. Date: Sep. 18, 2014

(54) Thermoforming Chain Rail Having Compact Anti-Torque Chain Support

(71) Applicant: IRWIN RESEARCH AND DEVELOPMENT, INC., Yakima, WA (US)

(72) Inventor: Dale L. Vantrease, Naches, WA (US)

(21) Appl. No.: 13/842,795

(22) Filed: Mar. 15, 2013

(51) Int. Cl. B65G 15/48

(52) U.S. Cl. CPC B65G 15/48
USPC 198/851

(57) ABSTRACT

A thermoformable web chain rail assembly is provided having a chain and a chain rail. The chain has a series of alternating and interconnected roller links and pin links. The pin links include at least one pin extending through an adjacent one of the roller links and the pin links. A terminal portion of the pin extends beyond the roller link and the pin link with a roller affixed for rotation about the terminal portion of the pin for each of the at least one pins. The chain rail has an upper conveying raceway and a lower return raceway. The upper raceway includes a first linear guide surface provided beneath the first roller of each chain link and a second linear guide surface provided above the second roller of each chain link.

### TECHNICAL FIELD

This disclosure pertains to chains and chain rails. More particularly, this disclosure relates to thermoforming chain rails and chains.

### BACKGROUND OF THE INVENTION

Techniques are known for conveying web and sheet materials through processing operations, such as conveyors for transporting a thermoformable web through a conveyor oven and a thermoforming machine. One conveyor uses a chain rail 11 and chain 13 shown in FIG. 3. More particularly, chain 13 includes elongate pins 17 that travel within slot 21 formed in an aluminum extrusion 23. Over time, pin 17 wears out and forms a flat surface due to sliding contact with extrusion 23 along slot 21. Roller 15 of chain 13 rides atop a flat shoulder, or raceway 19 integrally formed in extrusion 23. Improvements are needed in order to eliminate wear of pin 21 which reduces the ability of chain 13 to counteract lateral forces on chain 13 resulting from a pierced sheet imparting lateral forces to chain 13. Further improvements are needed because aluminum extrusion 23 also contains ports for cooling fluids, and aluminum extrusion over time can degrade and leak due to inter-granular corrosion. Further, formation of long sections of extrusion 23, which is typically anodized, is difficult to manufacture. Extremely long extruded parts are difficult to form and anodize, for example, such as typical chain rails of lengths around thirty feet in length. Accordingly, improvements are needed in corrosion resistance of materials and manufacturability of chain rails.

### SUMMARY OF THE INVENTION

According to one aspect, a thermoforming chain rail assembly is provided having a chain and a chain rail. The chain has a series of alternating and interconnected roller links and pin links. The roller link has a first bushing and a second bushing coupling together a first roller link plate with a parallel second roller link plate, a first roller and a second roller provided about the first bushing and the second bushing between the first roller link plate and the second roller link plate. The pin link has a first elongate pin and a second elongate pin coupling together a first pin link plate and a second pin link plate while overlapping the first roller link plate and the second roller link plate. The first elongate pin passes through the second bushing of the roller link and the second elongate pin passes through a first bushing of another roller link, the first elongate pin and the second elongate pin each extending through and beyond the first pin link plate and receiving a pin roller thereabout captured on each respective pin for rotation. The spike extends upwardly from one of the second roller link plate and the second pin link plate. The chain rail has an upper conveying raceway and a lower return raceway, the upper raceway including a first linear guide surface provided beneath the first roller of each chain link and a second linear guide surface provided above the second roller of each chain link.

According to another aspect, a thermoformable web chain rail assembly is provided having a chain and a chain rail. The chain has a series of alternating and interconnected roller links and pin links. The pin links include at least one pin extending through an adjacent one of the roller links and the pin links. A terminal portion of the pin extends beyond the roller link and the pin link with a roller affixed for rotation about the terminal portion of the pin for each of the at least one pins. The chain rail has an upper conveying raceway and a lower return raceway. The upper raceway includes a first linear guide surface provided beneath the first roller of each chain link and a second linear guide surface provided above the second roller of each chain link.

According to yet another aspect, a thermoformable web conveyor chain is provided. The chain has a series of alternating and interconnected roller links and pin links. The roller link has a first bushing and a second bushing coupling together a first roller link plate with a parallel second roller link plate, a first roller and a second roller provided about the first bushing and the second bushing between the first roller link plate and the second roller link plate. The pin link has a first elongate pin and a second elongate pin coupling together a first pin link plate and a second pin link plate while overlapping the first roller link plate and the second roller link plate. The first elongate pin passes through the second bushing of the roller link and the second elongate pin passes through a first bushing of another roller link, the first elongate pin and the second elongate pin each extending through and beyond the first pin link plate and receiving a pin roller thereabout captured on each respective pin for rotation. The spike extends upwardly from one of the second roller link plate and the second pin link plate.

### BRIEF DESCRIPTION OF THE DRAWINGS

Preferred embodiments of the disclosure are described below with reference to the following accompanying drawings.

FIG. 1 is perspective view from above of a portion of a thermoforming line including a conveyor oven and a web conveyor with a pair of chain rails and chains according to one aspect.

FIG. 2 is a perspective view from above of the thermoforming line and web conveyor of FIG. 1 with the conveyor oven removed.

FIG. 3 is a prior art thermoforming chain rail and chain cross-sectional view.

FIG. 4 is an exploded perspective view of one segment of a roller link and a pin link for the chain of FIGS. 1-2.

FIG. 5 is an outside perspective view of the segment of chain of FIG. 4.

FIG. 6 is an inside perspective view of the segment of chain of FIGS. 4 and 5.

FIG. 7 is a vertical sectional view of one chain rail taken along line 7-7 of FIG. 2.

FIG. 8 is an enlarged vertical side view of the right chain track assembly of FIG. 2 illustrating the right chain rail, but with portions removed to facilitate viewing, the right chain tensioner assembly, and the rear support rail assembly.

FIG. 9 is a left end view of the chain track assembly of FIG. 8.

FIG. 10 is a right end view of the chain track assembly of FIG. 8.

FIG. 11 is an upstream end view of the chain exit assembly of FIG. 8 according to an alternative construction.

FIG. 12 is an enlarged view of the alternative construction chain rail of FIG. 11 taken from encircled region 12 of FIG. 11.

FIG. 13 is perspective view from upstream of the chain exit assembly of FIGS. 11 and 12.

FIG. 14 is a perspective view of the chain rail assembly with the chain removed.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

In FIG. 1, a representation of an illustrative thermoformable web conveyor having a thermoforming chain rail assembly for supporting and moving a sheet of thermoformable material through an oven and a thermoforming machine is shown and identified by reference numeral 12. More particularly, conveyor 12 is shown extending through an oven 14, a thermoforming machine 16 and an exterior guard 18 of a thermoforming line 10. Conveyor 12 includes an end frame 20 at an upstream end, and is supported downstream by a frame 22 of thermoforming machine 16.

As shown in FIG. 2, oven 14 (of FIG. 1) has been removed in order to see components of thermoformable web conveyor 12. More particularly, conveyor 12 includes a pair of elongate and laterally spaced-apart chain track assemblies 24 and 26. Each chain track assembly 24 and 26 includes a structural support rail 28 and 30 affixed with fasteners to a respective chain, or frame rail 32 and 34. A chain drive and tension assembly 36 and 38 is provided at an upstream end of each chain rail 32 and 34, respectively. A chain exit end assembly 40 and 42 is provided at a downstream end of each chain rail 32 and 34, respectively. Support rails 28 and 30 are affixed at an upstream end to machine frame 22 and frame 22 of thermoforming machine 16 at a downstream end. Rails 28 and 30 serve as a structural reinforcement and support to chain rails 32 and 34, respectively. Except for improvements to chain rails 32 and 34 (and the contained chain), conveyor 12 is constructed according to teachings of U.S. Pat. No. 5,806,745, herein incorporated by reference. Chain rails 32 and 34, according to such teaching, can be laterally adjusted to match wide of a thermoformable web, or sheet being conveyed by conveyor 12 during a thermoforming operation. Optionally chain rails 32 and 34 can be stationary relative to one another.

FIG. 4 illustrates in exploded perspective view one segment of a roller link 46 and a pin link 48 for chain 44 as used in chain rails 32 and 34 (of FIGS. 1-2). Roller link 46 includes a first bushing 62 and a second bushing 64 coupling together a first roller link plate 50 with a parallel second roller link plate 52, a first roller 58 and a second roller 60 provided about the first bushing 62 and the second bushing 64 between the first roller link plate 50 and the second roller link plate 52. Pin link 48 includes a first elongate pin 70 and a second elongate pin 72 coupling together a first pin link plate 54 and a second pin link plate 56 while overlapping the first roller link plate 50 and the second roller link plate 52, the first elongate pin 70 passing through the second bushing 64 of the roller link 46 and the second elongate pin 72 passing through a first bushing 62 of another, adjacent and successive roller link (not shown). The first elongate pin 70 and the second elongate pin 72 each extend through and beyond the first pin link plate 54 and receive a pin roller 66 and 68, respectively, thereabout captured on each respective pin 70 and 72 for rotation.

As shown in FIG. 4, each roller link plate 50 and 52 includes a pair of cylindrical apertures 47, 49 and 51, 53, respectively, sized to receive bushing 62, 64 in press-fit and swaged relation therein. Each roller 58 and 60 includes a cylindrical inner bore 63 and 65 sized to receive an outer surface of each bushing 62 and 64, respectively. Bushing 64 includes an inner bore 69 sized to receive pin 70, whereas bushing 62 is sized to receive a pin 72 (from an adjacent pin link. Each pin link plate 54 and 56 includes a cylindrical inner bore 55, 57 and 59, 61 sized to receive an outer surface of each pin 70 and 72, respectively, in press-fit relation. Each roller 66 and 68 includes a cylindrical inner bore 71 and 73 sized to receive an outer surface of each bushing 71 and 73. Pin 72 also passes through a pair of adjacent roller link plates 50 and 52, in assembly, from an adjacent and subsequent roller link (not shown) provided between pin link plates 54 and 56. A pair of cylindrical end crimp fittings 74 and 76 are press-fit, or crimped, in assembly onto ends of each pin 70 and 72 by receiving the end of each pin 70 and 72 within a respective cylindrical bore 75 and 77 in each fitting 74 and 76. A spike is integrally formed in pin link plate 78 configured to pierce and convey an edge of a thermoformable web, or sheet being conveyed by the conveyor and chain rails of this design.

FIGS. 5 and 6 show an adjacent pair of roller link 46 and pin link 48 of chain 44 assembled together. Rollers 58 and 60 are laterally offset relative to rollers 66 and 68, which, in assembly within a chain rail, provides resistance to torque on spike 78 when piercing and engaging a thermoformable web. By making pins 70 and 72 longer (relative to bushing 58) than is otherwise needed to assembly together adjacent roller links and pin links, such as roller link 46 and pin link 48, rollers 66 and 68 are provided with a substantial lateral offset relative to rollers 58 and 60, which provides significant lateral torque resistance when chain 44 is carried within a chain rail and conveying a thermoformable web.

FIG. 7 illustrates detailed construction features of chain rail 34. Chain rail 34 is formed from one or more of formed, or bent, and/or welded pieces of metal. According to one construction, chain rail 34 is formed from stainless steel and steel, with thickened portions formed by welding together separate pieces to form a rail return block 96 comprising an elongate flat, rectangular support surface for primary rollers 58, 60 of chain 44 (see FIG. 4). Chain rail 24 forms part of chain track assembly 24. Chain rail 34 comprises two portions 81 and 83 secured together with threaded fasteners 86 and 88. Fasteners 86 and 88 also support an elongate chain rail block 80 centrally within chain rail 34, captured between portions 81 and 83. Grommets 87 and 89 surround the region where each fastener 86 and 88 is recessed into portions 81 and 83, respective. In the region where the chain rails span a thermoforming machine, such fasteners are recessed, and in other regions the fasteners can have raised heads (as shown in FIGS. 13 and 14). A stepped down cylindrical bushing 90 extends through an aperture in block 80, and a complementary bushing 92 is received coaxially about a reduced diameter portion of bushing 90. Bushings 90 and 92 serve to fix block 80 rigidly within rail 34 at a specific location. Block 80 forms an elongate, flat rectangular surface atop which rollers 62 and 64 are seated for rotation as chain 44 translates there above. Block 80 can be constructed from a steel material.

In addition, bushings 90 and 92, block 80 and fasteners 86 and 88 of FIG. 7 trap and secure a steel L-shaped anti-rotation bracket 82 having a flange, or leg 84 that counteracts against rollers 66 and 68, preventing a tendency for chain 44 to rotate due to lateral inward loads from a thermoformable web pulling spike 78 in an inward direction towards a center of the web. In one case, bracket 82 and chain rail 34 can comprise stainless steel, or some other suitable structural material with strength to counteract such torque on chain 44 by providing spaced-apart reaction surface 94 and bottom surface 91 of leg 84. A piece of thin spring steel 85 is further captured between bushing 92 and plate, or portion 81 in assembly. Spring steel 85 provides a hardened surface against which pins 70 and 72 of chain 44 slide down the top delivery path 94 and the bottom return path 96, reducing wear on the inner ends of pins 70 and 72. Finally, fluid cooling tubes 98 and 100 are welded via periodic apertures 97 and 99 in portion 83 to hold them therein. In one case, tubes 98 and 100 are constructed from stainless steel, or some other suitable corrosion-resistance metal.

FIG. 8 illustrates the mounting and travel path of chain 44 within chain rail 34. Chain rail 32 (of FIG. 2) is constructed in mirror image. More particularly, chain rail 34 supports an array of chain sprockets 101-106 for rotation, about which chain 44 is circuitously carried. Sprocket 102 is supported by a chain tensioning mechanism to hold chain 44 around such circuitous path. sprocket 103 is driven by a hexagonal drive shaft (and motor in synchronization with the opposite chain rain, driving chain 44 in rotation to move a thermoformable web along chain rail 34 from an entrance end near bracket 108 of chain drive and tension assembly 38 to an exit end near bracket 109 of chain exit end assembly 40.

FIG. 9 shows chain rail 34 of FIG. 8 from a left side, including bracket 108 and chain 44. FIG. 10 shows chain rail 34 of FIG. 8 from a right side, including bracket 109 and chain 44.

FIGS. 11-14 show a modified chain rail 134, similar to chain rail 34 of FIGS. 1-10, but including an optional gap-reducing plate 137 that is secured along an inner lip of chain rail 134 in order to force thermoformable web 135 down over spikes 78 on chain 44 (see FIG. 12) for cases where web 135 is made from a relatively thin sheet of material. FIG. 13 shows such construction near chain exit end assembly 42, including chain 44. FIG. 14 shows the same construction while omitting chain 44 for viewing purposes. Individual spaced-apart and recessed threaded fasteners 136 secure metal plate 137 within chain rail 134.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A thermoforming chain rail assembly, comprising:
a chain having a series of alternating and interconnected roller links and pin links,
a) the roller link having a first bushing and a second bushing coupling together a first roller link plate with a parallel second roller link plate, a first roller and a second roller provided about the first bushing and the second bushing between the first roller link plate and the second roller link plate,
b) the pin link having a first elongate pin and a second elongate pin coupling together a first pin link plate and a second pin link plate while overlapping the first roller link plate and the second roller link plate, the first elongate pin passing through the second bushing of the roller link and the second elongate pin passing through a first bushing of another roller link, the first elongate pin and the second elongate pin each extending through and beyond the first pin link plate and receiving a pin roller thereabout captured on each respective pin for rotation;
c) a spike extending upwardly from one of the second roller link plate and the second pin link plate; and
a chain rail having an upper conveying raceway and a lower return raceway, the upper raceway including a first linear guide surface provided beneath the first roller of each chain link and a second linear guide surface provided above the second roller of each chain link.

2. The chain rail assembly of claim 1, wherein the spike is integrally formed in the second roller link plate.

3. The chain rail assembly of claim 2, wherein the integrally formed spike extends transverse to a travel direction for the chain.

4. The chain rail assembly of claim 1, wherein the spike is formed in at least some of the second roller link plates of the chain.

5. The chain rail assembly of claim 1, wherein each of the roller link plates and each of the pin link plates comprise a figure-eight shaped piece of plate steel having a cylindrical aperture centrally located within each lobe of the figure-eight shaped piece.

6. The chain rail assembly of claim 1, wherein the spike is provided by one of the second roller links and the second pin links of the chain.

7. The chain rail assembly of claim 1, wherein the upper conveyor raceway of the chain rail comprises an elongate chain rail block affixed within the chain rail having a flat top surface providing the first linear guide surface of the upper conveyor raceway.

8. The chain rail assembly of claim 7, wherein the elongate chain rail block has a rectangular cross-section.

9. The chain rail assembly of claim 1, wherein the lower conveyor raceway of the chain rail comprises an elongate chain rail return block having a flat top surface providing the lower conveyor raceway.

10. The chain rail assembly of claim 1, wherein the chain rail includes an elongate angle bracket affixed within the chain rail having a right-angle flange with a bottom surface providing the second linear guide surface.

11. A thermoformable web chain rail assembly, comprising:
a chain having a series of alternating and interconnected roller links and pin links, the pin links including at least one pin extending through an adjacent one of the roller links and the pin links, a terminal portion of the pin extends beyond the roller link and the pin link with a roller affixed for rotation about the terminal portion of the pin for each of the at least one pins; and
a chain rail having an upper conveying raceway and a lower return raceway, the upper raceway including a first linear guide surface provided beneath the first roller of each chain link and a second linear guide surface provided above the second roller of each chain link.

12. The chain rail assembly of claim 11, further comprising a spike provided by one of the pin link and the roller link.

13. The chain rail assembly of claim 12, wherein the spike is integrally formed into a roller link plate of at least some of the roller links.

14. The chain rail assembly of claim 13, wherein the spike is formed in the roller link plate of each of the roller links.

15. The chain rail assembly of claim 11, wherein each roller link comprises a first bushing and a second bushing coupling together a first roller link plate with a parallel second roller link plate, a first roller and a second roller provided about the first bushing and the second bushing between the first roller link plate and the second roller link plate.

16. The chain rail assembly of claim 15, wherein each pin link comprises a first elongate pin and a second elongate pin coupling together a first pin link plate and a second pin link plate while overlapping the first roller link plate and the second roller link plate, the first elongate pin passing through the second bushing of the roller link and the second elongate pin passing through a first bushing of another roller link, the first elongate pin and the second elongate pin each extending through and beyond the first pin link plate and receiving a pin roller thereabout captured on each respective pin for rotation.

17. The chain rail assembly of claim 11, wherein the upper conveyor raceway of the chain rail comprises an elongate chain rail block affixed within the chain rail having a flat top surface providing the first linear guide surface of the upper conveyor raceway.

18. The chain rail assembly of claim 17, wherein the elongate chain rail block has a rectangular cross-section.

19. The chain rail assembly of claim 11, wherein the lower conveyor raceway of the chain rail comprises an elongate chain rail return block having a flat top surface providing the lower conveyor raceway.

20. The chain rail assembly of claim 11, wherein the chain rail includes an elongate angle bracket affixed within the chain rail having a right-angle flange with a bottom surface providing the second linear guide surface.
